(19) United States
(12) Patent Application Publication
(10) Pub. No.: US 2026/0273491 A1
(43) Pub. Date: Sep. 17, 2026

(54) APPARATUS FOR THE PRODUCTION OF NITRILES AND USE THEREOF

(71) Applicant: Evonik Operations GmbH, Essen (DE)

(72) Inventors: Ulf Bindernagel, Koeln (DE); Catrin Dorothee Becker, Frankfurt (DE); Thomas Müller, Altenstadt (DE); Martin Köstner, Darmstadt (DE); Zhen Li, Hanau (DE)

(73) Assignee: Evonik Operations GmbH, Essen (DE)

(21) Appl. No.: 19/167,162

(22) PCT Filed: Mar. 19, 2024
(86) PCT No.: PCT/EP2024/057216

§ 371 Date: Sep. 19, 2025

(30) Foreign Application Priority Data
Mar. 24, 2023 (EP) 23163941.0

(51) Int. Cl. B01J 19/00; B01J 8/02; B01J 12/00; B01J 19/24; C01C 3/02

(52) U.S. Cl. CPC B01J 19/0013; B01J 8/0278; B01J 8/0285; B01J 8/0292; B01J 12/007; B01J 19/24; C01C 3/0216; C01C 3/0225; C01C 3/0229; B01J 2208/00203; B01J 2208/00212; B01J 2208/00256; B01J 2208/00398; B01J 2208/00415; B01J 2208/00495; B01J 2219/0009; B01J 2219/00094; B01J 2219/00103; B01J 2219/00135; B01J 2219/00155

(57) ABSTRACT

It is an object of the invention to specify an electrically heatable reactor for hydrogen cyanide production and the production of other nitriles that enables a differentiated temperature profile and requires no more than inexpensive standard components. The core of the inventive apparatus (0) is a chamber (1) made of gas-permeable, thermally insulating material that constitutes the actual reaction space. Electrical heating elements (5) project into the chamber (1), such that the chamber (1) can be heated from the inside by the heating elements (5). The electrical terminals of the heating elements are outside the reaction space but within the surrounding shell. Unlike in the industrially implemented BMA process, the heat is thus not transported into the reaction space from the outside, but rather generated in the reaction space. The heat is generated by conversion of electrical energy by means of the heating elements (5) by the principle of resistance heating. In order to ensure the gas-tightness of the apparatus (0), a shell (9) is provided, which surrounds the chamber (1) in a gas-tight manner.

The invention relates to an apparatus for the production of at least one product gas from at least one reactant gas. In particular, the apparatus is intended for the production of nitriles. The invention further relates to the use of the apparatus in the production of nitriles, especially of hydrogen cyanide, and in the provision of negative control power.

Hydrogen cyanide (HCN), the simplest nitrile, is an important synthesis unit in organic chemistry. Hydrogen cyanide is usually produced on an industrial scale by the Andrussow process or the BMA process.

An introduction to the technology of hydrogen cyanide production is given by:
Gail, E., Gos, S., Kulzer, R., Lorösch, J., Rubo, A., Sauer, M., Kellens, R., Reddy, J., Steier, N. and Hasenpusch, W. (2011). Cyano Compounds, Inorganic. In Ullmann's Encyclopedia of Industrial Chemistry, (Ed.). DOI 10.1002/14356007.a08_159.pub3

In the BMA process (BMA=“Blausäure aus Methan und Ammoniak” [hydrogen cyanide from methane and ammonia]), hydrogen cyanide is produced from methane (CH₄) and ammonia (NH₃) in a strongly endothermic reaction which requires comparatively high reaction temperatures of 1000° C.-1300° C. In contrast to the Andrussow process, the BMA process is performed in the absence of oxygen. The need to use fossil energy carriers for provision of the enthalpy of reaction in conjunction with the low energy yield for the hydrogen cyanide results in significant generation of CO₂.

The combustion of natural gas or recycled hydrogen (H₂) formed as the by-product of the BMA process provides the energy required in the BMA process in a separate combustion space. Because of the necessary minimum temperatures for the hydrogen cyanide reaction, only some of the thermal energy used is utilized for the reaction itself; the rest is required for heating of the combustion air and the fuels.

As an alternative energy source, HCN can be produced with electrical energy rather than with fossil fuels. When electricity from renewable sources is used, the process is energetically very substantially CO₂-neutral. An electrically heated BMA process also has further advantages over a fossil fuel-heated BMA process, for example in terms of running costs:
As a result of avoidance of the inevitable energy loss on the combustion gas side because of the heating of the combustion air to the high minimum reaction temperature necessary, better energy efficiency is to be expected.
Since there is no need to use refractory materials for lining the reactor, faster startup and shutdown cycles are achieved.
A more homogeneous temperature regime permits higher yields, thus reducing the specific use amounts of methane and ammonia for hydrogen cyanide production. This is because it is known that homogeneous temperature distribution makes it possible to achieve markedly higher yields coupled with lower by-product formation.

In terms of capital costs too, an electrically heated BMA plant appears to have advantages over a thermally heated plant:
the absence of fuel gas and flue gas spaces allows a more compact construction and higher space-time yields,
and inexpensive modular interconnections are likewise possible.

Finally, an electrically operated BMA process is more sustainable:
the hydrogen-containing tail gas obtained can possibly replace natural gas as heating gas in downstream processes, and here achieve an additional reduction in CO₂.
Absence of refractory materials and a process design that permits a higher degree of automation allows marked minimization of flaring periods in the event of faults in operation.
The hydrogen in the tail gas obtained has a considerably lower CO₂ footprint than hydrogen produced from fossil hydrocarbons in a steam reformer and can be used as raw material for further chemical reactions, after any purification required.

For all these reasons there is an interest in developing a BMA process operated with electrical energy, by which hydrogen cyanide can be produced on an industrial scale.

Various concepts are known for production of HCN in electrically heated reactors:

Firstly, hydrogen cyanide production through the use of electrically heated fixed bed reactors is described, wherein the catalyst bed can be heated by induction; cf. WO2017186437A1.

Secondly, structured catalyst bodies, called monoliths, composed of electrically conductive material as described in WO2019228798A1 or WO2021/063799A1 are used. In the publications cited, the reactants are passed through the catalyst-coated channels of an electrically heated structure (resistance heating).

DE10317197A1 discloses a reactor for production of hydrogen cyanide by the BMA process, which can be provided either with induction heating or with resistance heating. Heating is effected by means of a module disposed in the reaction space, through which the reaction mixture flows longitudinally. The reactor is surrounded by thermal insulation and provided with a double jacket that provides gas-tight sealing. This double jacket is filled with an inert gas. A disadvantage of this reactor is a monolithic structure which makes it very difficult to accomplish faultless homogeneous manufacture from a green body, which is prone to material stress extending as far as cracks owing to thermal stresses and is considered to be costly and inconvenient for construction sizes on an industrial scale.

With regard to this prior art, it is an object of the present invention to specify an electrically heatable reactor for the production of gaseous products such as hydrogen cyanide and other nitriles, which is resistant to thermal (cycling) stress and has high availability of the heating elements, enables a differentiated temperature profile and needs no more than inexpensive standard components.

This object is achieved by an apparatus according to Claim 1. The invention therefore firstly provides an apparatus for the production of at least one product gas from at least one reactant gas, especially for the production of nitriles, comprising the following features:
a) the apparatus comprises a chamber having a gas-permeable and heat-insulating wall, having an inlet for the reactant gas, having an outlet for the product gas, and having a main flow direction that extends from the inlet to the outlet;
b) the apparatus comprises a gas-tight shell that surrounds the chamber, with the inlet and the outlet conducted through the shell;
c) an interspace is provided between chamber and shell, which surrounds the chamber and is itself surrounded by the shell;
d) the apparatus comprises at least one electrical heating element that extends through the chamber and penetrates the wall thereof at least once, and which has at least two electrical terminals disposed within the interspace and outside the chamber;
e) the apparatus comprises an electrical voltage source which is disposed outside the shell and is connected at least via a first electrical lead to the first electrical terminal of the heating element and via a second electrical lead to the second electrical terminal of the heating element, where the first and second electrical leads are conducted through the shell;
f) the apparatus comprises at least one terminal element for a filling gas source which is disposed outside the shell and which is connectable via a filling gas conduit to the interspace in a fluid-conducting manner in such a way that the interspace is chargeable with a filling gas drawn from the filling gas source;
g) a catalyst is disposed in the chamber.

The core of the inventive apparatus is a chamber that constitutes the actual reaction space. The electrical heating elements are present in the chamber, such that the chamber can be electrically heated from the inside by the heating elements. Unlike in industrially implemented BMA processes, the heat is thus not transported into the reaction space from the outside, but rather only generated in the reaction space. The heat is generated in the heating elements by conversion of electrical energy by the principle of resistance heating. Unlike in industrially implemented BMA processes, there is no loss of energy in the apparatus of the invention via flue gas which is obtained at reaction temperature. This markedly increases energy efficiency.

A major aspect of the apparatus according to the invention is that the heating elements pass through the wall of the chamber. This means that the heating elements are present not just within the chamber but also partly outside the chamber. The section of the heating elements within the chamber serves to heat the chamber. The sections of the heating elements outside the chamber serve for electrical connection. Each heating element has at least two sections outside the chamber because each heating element requires at least two electrical terminals. Each electrical terminal is in a section of the heating element outside the chamber.

Since the wall of the chamber is lined with a thermally insulating material and/or consists of a thermally insulating material, the temperature outside the chamber is lower than within the chamber, such that electrical contact-connection is easier to accomplish there.

The inventive passage of the heating elements through the wall is additionally based on the finding that sealing of the chamber in the region of the heating elements is not possible in any case. Because of thermal expansion, it is necessary to ensure sufficient tolerance in the passage of the heating elements in order to enable relative movement between wall and heating elements. According to the invention, the intention is that the passage of the heating elements through the wall be gas-permeable. The filling gas supplied is used to prevent passage of reactant or product gases into the interspace. This also means that the pressure in the interspace must always be at least the same as or higher than in the chamber in order to prevent reactant or product gases from exiting from the chamber.

In order to ensure the gas-tightness of the apparatus, according to the invention, a shell is provided, which surrounds the chamber in a gas-tight manner. In this way, the interspace is formed between the shell and the wall of the chamber. According to the invention, the interspace is charged with the filling gas, which cannot leave the interspace to the outside because of the gastightness of the shell. The filling gas is predominantly nitrogen or hydrogen or hydrocarbon, or a mixture of predominantly nitrogen and hydrogen and hydrocarbon. The filling gas may possibly include traces of other gases.

The filling gas may be recycled from the process downstream of the process, since the tail gas obtained in the BMA process may contain the above-recited filling gases.

The gas pressure in the interspace is under closed-loop control in operation such that it is continuously a little higher than the reaction pressure in the chamber. In this way, gases are very substantially prevented from getting into the interspace from the interior of the chamber. If this does happen, it is not a major problem because the shell is of gas-tight design. If, conversely, some of the filling gas gets into the chamber through the non-gas-tight wall, this is likewise uncritical.

The shell is manufactured from thermally conductive metal and also serves for removal of heat. For this purpose, the shell absorbs the thermal radiation emanating from the wall and dissipates it to the environment. Since the interspace between wall and shell is filled merely with filling gas, there is no impairment of thermal radiation from the wall to the shell.

In order to further improve removal of heat, the gas-tight shell may be provided with an additional heat exchanger. The heat exchanger is disposed outside the shell and is connected to the shell in a thermally conductive manner. The radiative heat absorbed by the shell is thus removed via the heat exchanger. The heat exchanger is preferably charged with a cooling fluid. For this purpose, the heat exchanger is connected in a fluid-conducting manner via a feed to a cooling fluid source and via a return to a cooling fluid sink. In this way, the cooling fluid flows from its source through the feed into the heat exchanger, where it absorbs the heat from the shell, and flows to the sink via the return. This generally increases the temperature of the cooling fluid, such that the temperature of the cooling fluid is higher in the return than in the feed. It is also conceivable to amalgamate the source and sink of the cooling fluid in a second heat exchanger and hence to create a cooling fluid circuit.

Suitable cooling fluids are air, gaseous or liquid nitrogen, gaseous argon, gaseous or liquid water, liquid oil, gaseous ammonia, gaseous hydrocarbon or mixtures thereof. The cooling fluid may alter its thermodynamic state in the heat exchanger, for instance evaporate. It is also conceivable to use the reactant gas mixture as cooling fluid and to preheat it in the heat exchanger. The return then leads directly into the chamber or via the inlet into the chamber. The chamber serves in this sense as a coolant sink.

There are various useful embodiments of the heat exchanger. In a first embodiment, the gas-tight shell has a jacketed design (double jacket). A cavity formed between the two walls of the jacket is filled with the cooling fluid. Heat is then transferred directly from the inner wall of the double jacket to the cooling fluid. The cooling fluid-filled double jacket has the advantage that the cooling fluid additionally provides protection from escape of gas if the inner shell should fail.

Alternatively, it is conceivable that the heat exchanger is designed as a cooling coil wound around the shell. The cooling coil constitutes a connection between the feed and return of the cooling fluid.

In the simplest case, the cooling coil is a cooling fluid-filled pipe connected via heat bridges to the outside of the gas-tight shell. The pipe, like the shell, consists of steel. The heat bridges are steel elements welded to the pipe and the shell. The steel elements thus serve to secure the cooling coil on the shell and serve as a heat bridge between shell and cooling coil.

Alternatively, the cooling coil may be obtained in that an open profile is welded onto the outside of the gas-tight shell. The cooling fluid is then at least partly between the profile and the outside of the gas-tight shell. This embodiment has the advantage that heat is transferred directly from the shell into the cooling fluid—avoiding the circuitous route via heat bridges.

The wall of the chamber preferably has a multilayer design. It preferably comprises an outer shell of metal and an insulation made of a thermally insulating material disposed on the inside of the shell. The metal shell stabilizes the chamber and releases the thermal radiation into the interspace. In order to keep the outflow of heat low, an insulation made of a thermally insulating material is used, having much lower thermal conductivity than the metallic shell.

The insulation is preferably manufactured from a mineral or ceramic material having high thermal stability and low specific thermal conductivity. Preference is given to using mineral microfibre boards as insulation.

It is also conceivable to use a multilayer thermal insulation, in which case the individual layers of the thermal insulation have different specific thermal conductivity.

More preferably, the thermally insulating wall on the chamber side comprises an inner layer with a continuous surface. A continuous surface is understood to mean that the surface is very substantially free of pores. This can be achieved, for example, in that individual structural elements with suitable surface area are arranged one on top of another in an offset manner. In particular, the wall may be provided on its inside with metallic or ceramic elements that do not consist of fibre material. Metallic and ceramic elements may be manufactured in very substantially pore-free form by technologies that are customary for these materials.

In a particularly preferred embodiment, the inner wall towards the chamber has been provided on its surface with a catalytically active or activatable coating containing the catalyst. This makes the wall of the chamber itself catalytically active, which prevents deposits on the thermal insulation.

It may be advantageous when the chamber, viewed in main flow direction, has an out-of-round cross section. In particular, it makes sense for the chamber, viewed in main flow direction, to have a rectangular cross section. The heating elements can be distributed more uniformly over a rectangular cross section.

With regard to the arrangement of the heating elements, it should be noted that this is preferably done in such a way that the heating elements, viewed in main flow direction, are arranged in succession or arranged offset from one another. If the heating elements, viewed in main flow direction, are arranged in succession, a clear passage is formed between the heating elements, which lowers the flow resistance. If the heating elements are arranged offset from one another in succession, the flow resistance is higher because there is no free passage, but all flow pathways come into contact with heating elements, and so the heat transfer is more intensive.

It is particularly preferable when the innermost layers of the thermally insulating wall having the continuous surface have high thermal cycling stability. This is achieved by material selection and processing. High thermal cycling stability has the advantage that the apparatus can be quickly heated up and cooled down again without damage to the thermal insulation of the wall.

This is advantageous especially when the reactor can be utilized for provision of negative control power in the context of power grid stabilization. Conventional BMA reactors have a refractory lining that has to be heated up or cooled over several hours in order not to break. This is much too slow for the provision of control power within a matter of minutes.

The invention further provides for the use of the apparatus of the invention for provision of negative control power for the purpose of stabilization of power grids. The apparatus can preferably be used to provide a negative minute reserve. What is meant by negative control power is that the apparatus is supplied with voltage drawn from the electrical voltage source only when there is an oversupply of electrical power in the grid to which the electrical voltage source is connected. Conversely, the apparatus can also be disconnected from the electrical voltage source if there is an undersupply of electrically available power. In both ways, the grid incorporating the electrical voltage source is stabilized. This is of interest especially when many natural power sources such as wind power or photovoltaics are being used in the grid, the power output from which fluctuates significantly.

One advantage of the inventive construction of the apparatus is that it is possible to use conventional, commercially available heating elements as resistance heating, as used in conventional, electrically heated industrial furnaces. There is no need for a special construction of the electrical resistance heating or costly 3D printing.

Electric heating elements are commercially available from silicon carbide or molybdenum silicide or other materials, and are stable under the reaction conditions.

It is advantageous when the heating elements are aligned transverse to the flow. The effect of this is that the heating elements experience only small temperature differences. Since the apparatus of the invention is set up for operation in a continuous process, regions with approximately the same temperature that extend through the chamber arise in operation, essentially transverse to the main flow direction of the reactants through the chamber. If the heating elements are arranged in this direction, the stress on the heating elements resulting from differences in temperature is very small.

Furthermore, the heating elements are controllable separately in a simple manner. The use of separately controllable heating elements optionally enables the establishment of a temperature profile in order thus to control the temperature progression of the reaction in a targeted manner. For instance, it is possible to optimize the conversion and yield of the reaction and to suppress the formation of unwanted by-products. The temperature profile is adjusted via closed-loop control of electrical power: the establishment of a power profile over the length of the reactor results in a temperature profile.

The preferred embodiment of the apparatus is guided by the design of commercially available heating elements. These are preferably I-shaped, U-shaped, W-shaped or M-shaped. All these heating elements have a theoretical main resistance axis that should be aligned transverse to the flow direction.

The heating elements are essentially of cylindrical shape, but may also have different cross sections, for example an elliptical cross section. The I-shaped heating elements have exactly two electrical terminals, i.e. one at each end. When installed, the I-shaped heating elements extend through the chamber in a linear manner and project beyond the wall with their terminal electrical connections. The main resistance axis thereof corresponds to the longitudinal axis thereof.

The U-shaped heating elements also have two electrical terminals, i.e. one at each open end of the limbs. The terminals are thus on the same side. When installed, the two limbs extend through the chamber in a parallel manner. The limbs penetrate the wall, such that the ends with the electrical terminals project out. The main resistance axis corresponds to the axis of symmetry.

The W-shaped heating elements correspond to a double U and have three electrical terminals. They are intended for use in three-phase grids. The main resistance axis corresponds to the axis of symmetry.

The heating elements are preferably installed in such a way that the main resistance axis forms an angle φ with the main flow direction of at least 0° and at most 90°. More preferably, the angle φ is 90°. The main resistance axis of the heating elements is then at right angles to the main flow direction. This is the most favourable configuration in terms of flow and thermodynamics.

The apparatus is preferably set up such that the main flow direction runs vertically, i.e. parallel to the acceleration due to gravity. In this way, the main flow direction is not steered by gravity, such that the alignment of the heating elements relative to the flow is maintained. The main flow direction thus preferably runs upwards, counter to the acceleration due to gravity. This prevents thermal buoyancy transverse to the flow direction.

There is preferably a multitude of heating elements installed in the apparatus. These may be connected in an electrically conductive manner to the first and second electrical leads and if appropriate also to the third electrical lead by series, parallel or star connection, or by a mixture of these connections.

Preference is given to using heating elements made of silicon carbide or of molybdenum silicide that are coated with catalyst. It may be advisable to provide a protective coating on the surface of the heating elements, to which the catalyst is applied. This prevents chemical or physical reaction between catalyst and core.

Alternatively, the catalyst can be applied to a conventional, unheated catalyst support and introduced into the chamber.

Since short-circuit flows can form in the region of the wall, this can lead to a suboptimal progression of the reaction. In order to avoid the formation of unwanted flow regimes, it is additionally possible to introduce unheated heating elements.

The inventive construction of the apparatus thus opens up a multitude of benefits that are especially apparent in the production of product gases such as hydrogen cyanide or other nitriles, for example aceto-or acrylonitrile.

The invention therefore secondly provides a process for producing nitriles using the apparatus according to the invention. Such a process has the following steps:
a) providing an apparatus according to the invention;
b) supplying the inlet with a reactant gas mixture comprising at least ammonia and gaseous hydrocarbon;
c) supplying the heating element with electrical current drawn from the electrical voltage source;
d) drawing a product gas mixture comprising at least one nitrile formed from the outlet.

Preferably, hydrogen cyanide is produced in this way. The hydrogen cyanide is a nitrile which is obtained in the product gas mixture. For this purpose, the hydrocarbon methane must be present in the reactant gas mixture. If hydrogen cyanide is to be produced, the catalyst used is a material containing platinum.

If the reactant gas mixture additionally contains oxygen, the result is a potentially ignitable mixture. A mixture is ignitable if the concentration of oxygen KO₂ within the reactant gas mixture is above the limiting oxygen concentration SGK of the mixture. The limiting oxygen concentration SGK depends on the composition of the reactant gas mixture and can be found in corresponding tabular works. The reactant gas mixture preferably includes so little oxygen that the concentration of oxygen KO₂ is below the limiting oxygen concentration SGK. This means that the reactant gas mixture is not ignitable. This makes it possible to ensure safe operation with a lower level of complexity.

A process for producing hydrogen cyanide which is operated below the ignition limit can be regarded as a BMA process. Since the thermal energy required for the reaction is provided electrically, it is referred to hereinafter as “E-BMA process”.

Unlike the conventional, thermally heated BMA and Andrussow processes, the E-BMA process enables virtually complete conversion of the reactants by means of electrical energy, and in the case of use of green power even in a potentially CO₂-neutral manner. (The methane used in the Andrussow process will always be partly converted to CO₂ because of the process characteristics.)

Because of the particular construction of the apparatus according to the invention, it is possible to optimize the E-BMA process operated thereby with regard to yield and conversion such that it is competitive with conventional BMA and Andrussow processes.

As well as E-BMA processes, the apparatus according to the invention can also be used for similar reactions, for example for the production of aceto-and acrylonitrile.

The apparatus according to the invention is set up for operation at a reaction pressure PR within the chamber of at least 1*10⁵ Pa absolute and at most 5*10⁵ Pa absolute. There is preferably a slightly greater gas pressure p_{c} in the interspace in order to create a small pressure gradient relative to the reaction space. In this way, the wall of the reaction space is virtually unpressurized. The positive pressure relative to ambient pressure is borne here by the wall of the shell. The wall of the shell should be designed in a correspondingly pressure-rated manner.

The gas pressure p_{c} in the interspace is expended by the filling gas. The filling gas is predominantly nitrogen or hydrogen or methane, or a mixture of predominantly nitrogen, hydrogen and methane. The filling gas may possibly include traces of other gases.

The process is preferably operated in such a way that the flow towards the heating elements in the reaction space is uniform, such that, with constant surface output, a virtually constant temperature profile is formed over the respective heating element. In this way, the heating elements are better able to cope with the thermal stress. The lifetime of the heating elements is extended.

The temperature window for the reaction is between 800° C. and less than 1500° C. The reaction temperature is not necessarily identical at all sites in the chamber, but may assume different values within the temperature window mentioned. The intermediate temperature To in the interspace is less than 400° C., preferably less than 150° C.

In order to keep the temperature in the interspace at less than 400° C., a cooling fluid is preferably used to remove heat from the shell via a heat exchanger. For this purpose, the cooling fluid is drawn continuously from the cooling fluid source, the heat exchanger is supplied continuously with the cooling fluid, and cooling fluid is drawn off continuously from the heat exchanger, where the cooling fluid temperature is lower in the feed than in the return.

In a particular embodiment, the reactant gas mixture is utilized as cooling fluid. The cooling fluid sink used is then the chamber of the apparatus. In this way, the reactant gas mixture is preheated and the heat is recovered.

### WORKING EXAMPLES

The invention is now to be elucidated by working examples. In this regard, the figures show:

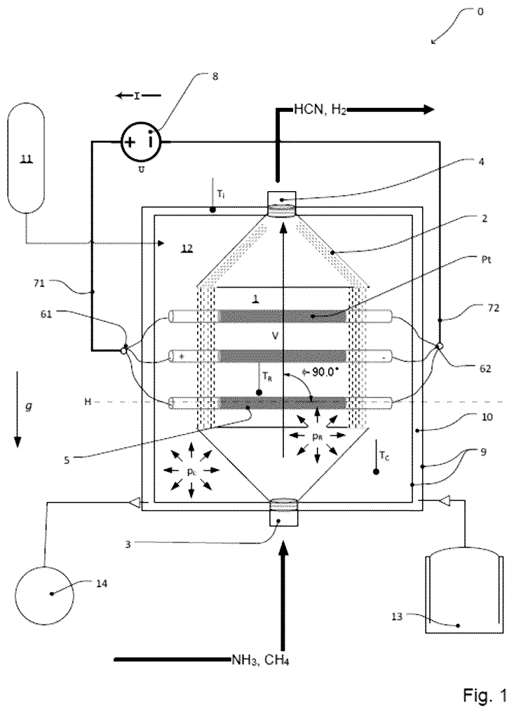

FIG. 1 first embodiment of the apparatus (linear heating elements), schematic;

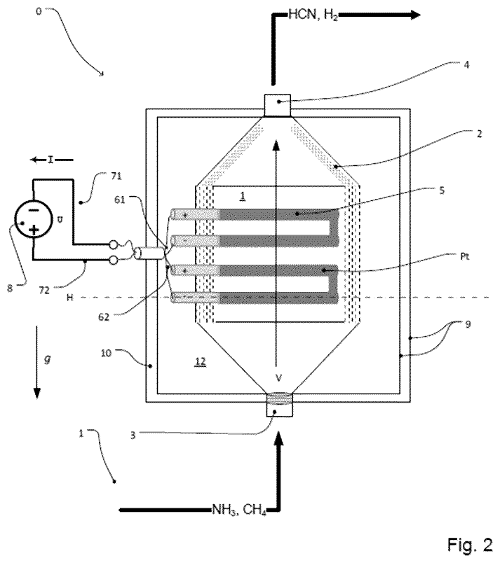

FIG. 2 second embodiment of the apparatus (U-shaped heating elements), schematic.

FIG. 1 shows the inventive apparatus 0 in schematic form. The apparatus 0 comprises a chamber 1 with a non-gas-tight wall 2. The wall 2 comprises a thermally insulating material, around which is a shell of metallic material. Within the chamber 1, a chemical reaction is conducted. The chamber 1 thus constitutes the reaction space.

The chemical reaction, by way of example, is the reaction of methane CH₄ with ammonia NH₃ in the absence of oxygen O₂, forming hydrogen cyanide HCN and hydrogen H₂ (E-BMA process).

The reactant stream, containing predominantly methane CH₄ and ammonia NH₃, is guided into the chamber 1 as a gas mixture through an inlet 3 via a distributor device (e.g. a perforated plate). The products hydrogen cyanide HCN and hydrogen H₂, and unconsumed reactants and by-products, are likewise drawn off from the chamber 1 in gaseous form, namely via an outlet 4 provided for the purpose.

Thermal energy is required for the chemical reaction. This is generated in accordance with the invention by conversion of electrical energy within the chamber 1. The heat is required at a temperature level in the range between 800° C. and 1500° C. (reaction temperature T_{R}).

For this purpose, a multitude of heating elements 5 is provided in the chamber 1, which extend through the chamber 1. The heating elements 5 in the simplest case are cylindrical elements made of silicon carbide. Silicon carbide is very thermally stable and, because of its physical properties, is frequently used in practice for conversion of electrical energy to heat. Each heating element 5 has at least two electrical terminals +/−. Because of the high reaction temperature (T_{R}=800° C. to 1500° C.) within the chamber 1, it is important that the electrical terminals (+/−) of the heating elements 5 are outside the chamber 1. For that reason, the heating elements 5 extend through the wall 2 of the chamber 1. In the region of the passage, a sleeve is disposed in each case between the wall and heating element (not shown). Since the wall 2 consists of thermally insulating material and the apparatus 0 has active cooling, which will be described later, the temperature outside the chamber 1 is much lower in the region of the electrical terminals +/−; it is, for instance, less than 400° C. This temperature is called intermediate temperature T_{c} here.

In this lower temperature range, the electrical terminals +/− are respectively connected by a first interconnection 61 and a second interconnection 62 to a first electrical lead 71 and to a second electrical lead 72. The interconnections 61, 62 may be a series connection (not shown) or a parallel connection (shown), or a mixture of the two. In three-phase grids, a star connection is also possible (not shown). The first and second electrical leads 71, 72 lead to an electrical voltage source 8. In three-phase grids, a third electrical lead to the voltage source 8 is required (not shown).

The voltage source 8 provides the energy needed for the process in electrical form. All the energy needed for the chemical conversion of methane and ammonia to hydrogen cyanide and hydrogen is preferably provided in electrical form.

In operation, the electrical heating elements are supplied via the electrical leads 71, 72 and the interconnections 61, 62 with an electrical voltage U drawn from the electrical voltage source 8, such that an electrical current/flows through the electrical heating elements 5. The heating elements 5 convert the electrical energy to thermal energy, which heats the surface of the heating elements. This enables the reaction.

By contrast with the conventional thermally heated BMA process, the heat required for the reaction is not introduced into the chamber 1 from the outside but generated in situ in the reaction space with the heating elements 5.

In order to increase the reaction rate, a catalyst is used in the chamber 1. The catalyst may contain platinum and has preferably been applied to the surface of the heating elements 5.

The hydrogen cyanide HCN produced in the process is highly toxic. In order to prevent escape of the hydrogen cyanide, the chamber 1 is surrounded by a gas-tight shell 9 in a double-wall design as a double jacket. The double jacket 9 serves simultaneously as a heat exchanger 10 filled with a cooling fluid.

In order that the gaseous reactants CH₄, NH₃ pass through the gas-tight shell 9 into the chamber 1 and the products HCN, H₂ and unconverted reactants, and also by-products pass out of the chamber 1 again, the inlet 3 and the outlet 4 are each conducted through and sealed gas-tight with respect to the shell 9.

An interspace 12 extends between the shell 9 and chamber 1. The heating elements 5 extend through the wall 2 of the chamber 1 into the interspace 12, where the electrical terminals +/− thereof are present.

The passage of the heating elements 5 through the wall 2 is not gas-tight because a certain mobility of the heating elements 5 with respect to the wall 2 is required here owing to thermal expansion. The wall 2 of the chamber 1, unlike the shell 9, is not gas-tight either, and therefore reaction participants could potentially pass from the chamber 1 into the interspace 12. In order to prevent this, the interspace 12 can be charged statically with a filling gas which may optionally contain small amounts of the reactants and which has a pressure gradient relative to the reaction space. The filling gas is drawn from a filling gas source 11 and is passed into the interspace 12 through a filling gas conduit (not shown) and a connecting element (not shown).

In a similar manner, the double jacket 9 is charged from the inside with a cooling fluid which is drawn from a cooling fluid source 13. However, the cooling fluid is drawn off again from the shell 9 to a cooling fluid sink 14. The cooling fluid thus flows from its source 13 through the shell 9 to a sink 14. In this way, heat is removed from the double jacket 9 via the cooling fluid. The double jacket 9 acts simultaneously as a heat exchanger 10. The apparatus 0 thus receives active cooling. For this purpose, the cooling fluid used is a substance having good specific heat capacity, for instance liquid water or liquid oil. The heat removed via the cooling fluid to the sink 14 is heat that has been transferred by thermal radiation from the metallic shell of the wall 2 to the double jacket 9. Because of the insulation of the wall 2, this amount of heat is relatively small.

As an alternative to the double jacket 9, the heat exchanger 10 may also be implemented with a cooling coil wound around the jacket 9 (not shown). The shell 9 may then have a single-wall design, since the cooling fluid flows through the cooling coil.

If the gas pressure pc of the filling gas in the interspace 12 is only slightly greater than the reaction pressure PR in the chamber 1, the wall 2 of the chamber 1 is barely under any mechanical stress. In particular, it does not need to withstand a significant internal pressure. Consequently, the wall 2 may be optimized with regard to thermal insulation. By contrast, the double jacket 9 is under pressure stress. This is because, by contrast with the wall 2 of the chamber 1, it has to withstand an internal pressure corresponding to the difference between the gas pressure p_{c} and the ambient pressure p₀. Since the shell 9 is not under such significant thermal stress—the temperature Tᵢ of the cooling fluid within the shell 9 is usually less than 100° C.—safe pressurization is much easier to accomplish here. Moreover, the double jacket 9 may consist of steel, which is not thermally insulating but is more mechanically durable than an insulation material contained in the wall 2 of the chamber 1. The wall 2 in the apparatus according to the invention thus solely fulfils the function of thermal insulation, while the function of gastightness and pressure retention is assumed by the shell 9.

A further important aspect of the apparatus according to the invention is the alignment of its heating elements 5 in relation to acceleration due to gravity g and the main flow direction V of the reaction participants:

The main flow direction V extends from the inlet to the outlet through the chamber 1. The reactants CH₄, NH₃ flow into the chamber 1 along this main flow direction V, and the products HCN, H₂ and unconverted reactants and by-products flow back out of the chamber 1.

In the embodiment of an apparatus according to the invention shown in FIG. 1, the heating elements 5 are arranged transverse to the main flow direction V, such that the longitudinal axis H of the heating elements 5 forms an angle φ of 90° with the main flow direction V.

This has the advantage that every heating element 5 experiences merely small temperature differences: this is because the reaction temperature T_{R} is not the same throughout the chamber 1 but changes in the main flow direction V. One reason for this is that the temperature changes because of advancing conversion in the main flow direction. Secondly, the heating elements 5 may also be set to different temperature via the supply of power in order to impose an optimal temperature profile on the reaction in the main flow direction. The supply of power and hence ultimately also the temperature can be adjusted via the size of the current which is drawn from the voltage source 8.

If the heating elements 5 are arranged transverse to the main flow direction V, the temperature profile at the position of an individual heating element is virtually constant. Consequently, the thermal expansion of the heating element is constant over its entire length, which in turn improves its stability.

In the embodiment of an apparatus according to the invention which is shown in FIG. 1, the main flow direction V is arranged vertically, and counter to the acceleration due to gravity g. The flow through the chamber 1 is thus preferably from the bottom upward; other flow directions are likewise possible if required by the design.

Provided that the main flow direction V extends vertically and the longitudinal axis of the heating elements 5 transverse thereto at 90°, the longitudinal axis H of the heating elements 5 optimally runs horizontally.

In the embodiment shown in FIG. 1, the apparatus 0 has cylindrical heating elements 5 in which the longitudinal axis H is arranged horizontally.

If heating elements in a different design are chosen, the alignment within the chamber should be chosen correspondingly.

Thus, FIG. 2 shows a second embodiment of an inventive apparatus 0 in which the thermal resistors 5 are U-shaped. In order to align U-shaped heating elements along an isotherm, the limbs of the U should be aligned transverse to the main flow direction V and should be positioned in the chamber 1 in the same place in the main flow direction V. The limbs of the U may be at the same height in a vertical main flow direction V (not shown). In this respect, U-shaped heating elements, just like cylindrical heating elements, extend along a main resistance axis H arranged transverse to the main flow direction V. The limbs of the U run parallel on either side of the main resistance axis H, which corresponds to the axis of symmetry of the U. In the case of cylindrical heating elements (FIG. 1), the longitudinal axis corresponds to the main resistance axis H.

Essential aspects of the invention are to be summarized once again:

It is an object of the invention to specify an electrically heatable reactor for hydrogen cyanide production and the production of other nitriles that enables a differentiated temperature profile and requires no more than inexpensive standard components. The core of the inventive apparatus 0 is the chamber 1 made of gas-permeable, thermally insulating material that constitutes the actual reaction space. The electrical heating elements 5 project into the chamber 1, such that the chamber 1 can be heated from the inside by the heating elements 5. The electrical terminals of the heating elements are outside the reaction space but within the surrounding shell. Unlike in the industrially implemented BMA process, the heat is thus not transported into the reaction space from the outside, but rather generated in the reaction space. The heat is generated by conversion of electrical energy by means of the heating elements 5 by the principle of resistance heating. In order to ensure the gas-tightness of the apparatus 0, the shell 9 is provided, which surrounds the chamber 1 in a gas-tight manner.

### Experiments

The advantageous effect of the apparatus according to the invention is illustrated by the experiments that follow.

The experiments are simulations with the aid of Computational Fluid Dynamics (CFD). The Ansys Fluent software (Fluent version 2021R2) was used.

The reaction space is rectangular and contains about 900 heating elements.

In all three experiments, the synthesis gas consists of ammonia and methane in a molar ratio of 1.1:1 at an absolute pressure of 2.8 bar (2.8*10⁵ Pa). The gas is preheated to 200° C.; the reactant flow rate is 1440 kg/h. The simulations are conducted under adiabatic conditions at a heating output of 4.1 MW.

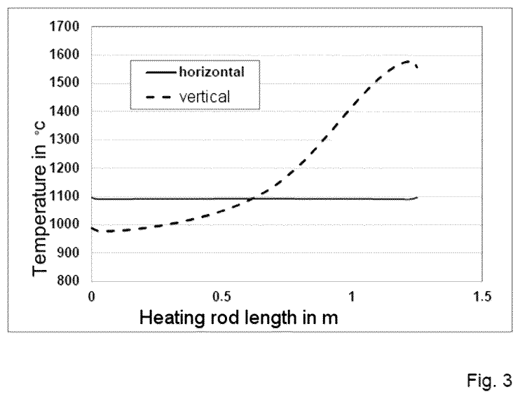

The results of the simulations are shown in graph form in FIGS. 3 to 6:

FIG. 3: Temperature along a heating element in the centre of the reactor with horizontal and vertical alignment of the heating elements;

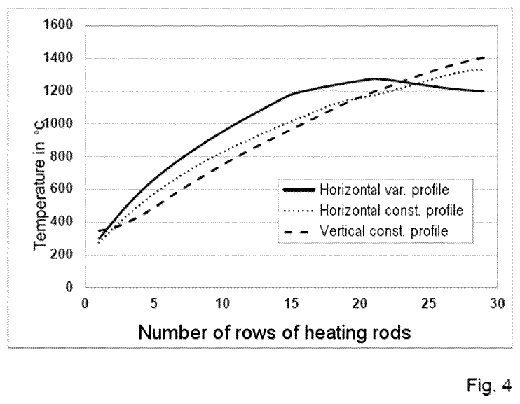

FIG. 4: Temperature progression through the reactor;

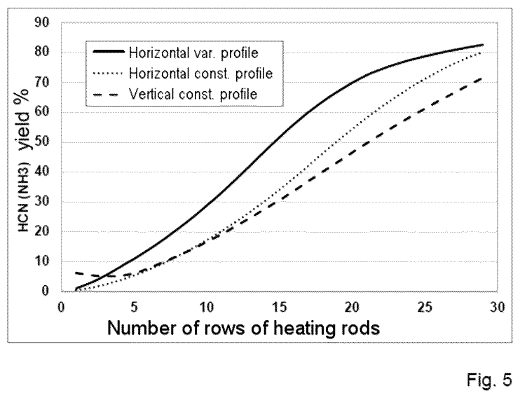

FIG. 5: Progression of Yield;

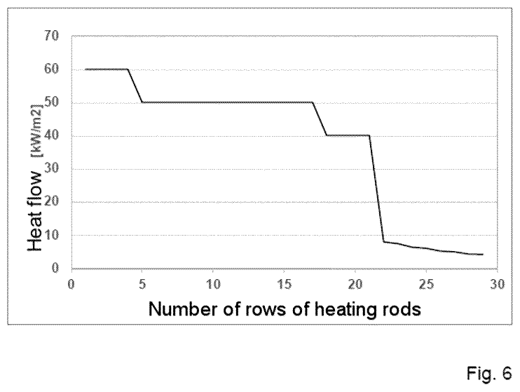

FIG. 6: Progression of power profile in experiment 3.

### Experiment 1 (Vertical Alignment of the Heating Elements—Constant Power)

The heating elements are vertical, i.e. arranged parallel to acceleration due to gravity, and the flow through the reactor is in horizontal direction. The power of the heating elements in the example described here is set to 38 kW/m².

Because of thermal buoyancy, temperature gradients of 500 to 700 K may exist along the heating element (cf. broken line in FIG. 3), which could adversely affect the lifetime of the heating element.

The temperature progression through the reactor is indicated in the dashed line in FIG. 4. The yield of HCN based on NH₃ is shown in the dashed line in FIG. 5. The yield is 72%.

### Experiment 2 (Horizontal Alignment of the Heating Elements—Constant Power)

The operating parameters of Experiment 1 were retained, i.e. the power of the heating elements is likewise set here to a constant 38 kW/m². However, the heating elements are arranged horizontally and the flow through the reactor is from the bottom upward.

Because of the horizontal arrangement of the heating elements, a relatively homogeneous temperature is established across each heating element, which can have a positive effect on the lifetime of the heating element (cf. solid line in FIG. 3).

The temperature progression is indicated in the dotted line in FIG. 4. The yield of HCN based on NH₃ is shown in the dotted line in FIG. 5. The maximum gas temperature is above 1400° C., which can adversely affect the lifetime of the heating element. The yield of HCN based on NH₃ is 80%.

### Experiment 3 (Horizontal Alignment of the Heating Elements With Variable Power Profile)

The heating elements are arranged horizontally and the flow through the reactor is from the bottom upward. The power of the heating elements is controlled by means of a profile, with variation of the power between 4 and 60 kW/m². The progression of the power profile is shown in FIG. 6.

Because of the horizontal arrangement of the heating elements, a virtually homogeneous temperature is established across each heating element, which can have a positive effect on the lifetime of the heating element. The temperature progression over the rod length is shown in the solid line in FIG. 3.

The temperature progression through the overall reactor is shown in FIG. 4 (solid line). The maximum gas temperature is in the region of 1300° C. Because of the power profile that drops toward the end (FIG. 6), the temperature also decreases again toward the end in Experiment 3 (solid line in FIG. 4).

The yield of HCN based on NH₃ is shown in the solid line in FIG. 5. The yield of HCN based on NH₃ is 83% and is thus higher than in Experiments 1 and 2.

### Conclusion

The highest yield is achieved when the heating elements are arranged horizontally and a variable power profile is implemented. Moreover, horizontal heating elements suffer less thermal stress.

### LIST OF REFERENCE SYMBOLS

0 apparatus
1 chamber
2 wall
3 inlet
4 outlet
5 heating element
61 first interconnection
62 second interconnection
71 first electrical lead
72 second electrical lead
8 electrical voltage source
9 shell (in double-jacket design)
10 heat exchanger
11 filling gas source
12 interspace
13 cooling fluid source
14 cooling fluid sink
+ first electrical terminal
− second electrical terminal
Pt platinum catalyst
T_{R} reaction temperature
T_{c} intermediate temperature
Tᵢ cooling fluid temperature
p_{R} reaction pressure
p_{c} backpressure
p₀ ambient pressure
CH₄ methane
NH₃ ammonia
HCN hydrogen cyanide
H₂ hydrogen
O₂ oxygen
g acceleration due to gravity
V main flow direction
H main resistance axis
φ angle

1. Apparatus (0) for production of at least one product gas from at least one reactant gas, especially for the production of nitriles, comprising the following features:
a) a chamber (1) having a gas-permeable and heat-insulating wall (2), having an inlet (3) for reactant gas, having an outlet (4) for product gas, and having a main flow direction (V) that extends from the inlet (3) to the outlet (4);
b) a gas-tight shell (9) that surrounds the chamber (1), with the inlet (3) and the outlet (4) conducted through the shell (9);
c) an interspace (12) which is disposed between chamber (1) and shell (9) and which surrounds the chamber (1) and is itself surrounded by the shell (9);
d) at least one electrical heating element (5) that extends through the chamber (1) and penetrates the wall (2) thereof at least once, and which has at least two electrical terminals (+,−) disposed within the interspace (12) and outside the chamber (1);
e) an electrical voltage source (8) which is disposed outside the shell (9) and is connected at least via a first electrical lead (71) to the first electrical terminal (+) of the heating element (5) and via a second electrical lead (72) to the second electrical terminal (−) of the heating element (5), where the first and second electrical leads (71, 72) are conducted through the shell (9);
f) at least one terminal element for a filling gas source (11) which is disposed outside the shell (9) and which is connectable via a filling gas conduit to the interspace (12) in a fluid-conducting manner in such a way that the interspace (12) is chargeable with a filling gas drawn from the filling gas source (11);
g) a catalyst disposed in the chamber (1).

2. Apparatus (0) according to claim 1, characterized by at least one heat exchanger (10) which is disposed outside the gas-tight shell (9) and is connected to the shell (9) in a thermally conductive manner.

3. Apparatus (0) according to claim 2, characterized in that the heat exchanger (10) comprises a cooling fluid, and in that the heat exchanger (10) is connected in a fluid-conducting manner via a feed to a cooling fluid source (13) and via a return to a cooling fluid sink (14).

4. Apparatus (0) according to claim 3, characterized in that the gas-tight shell (9) has a jacketed design as a double jacket (9), and in that the cooling fluid is conductable at least partly within the double jacket (9).

5. Apparatus (0) according to claim 3, characterized in that the heat exchanger (10) comprises a cooling coil which connects the feed to the return in a cooling fluid-conducting manner and is wound around the shell (9), in particular the cooling coil is designed as a tube connected to the outside of the gas-tight shell (9) via heat bridges or an open profile is welded onto the outside of the gas-tight shell (9), and wherein a cooling fluid is conductable at least partly between the profile and the outside of the gas-tight shell (9)

6. (canceled)

7. (canceled)

8. (canceled)

9. Apparatus (0) according to any of the preceding claims, characterized in that the electrical heating element (5)
has exactly two electrical terminals (+,−) and extends through the chamber (1) in a linear manner,
has exactly two electrical terminals (+,−) and extends through the chamber (1) in a U shape or M shape,
has exactly three electrical terminals and extends through the chamber (1) in a W shape. or
combinations of the electrical terminals extending in a U, M or W shape.

10. (canceled)

11. Apparatus according to claim 9, wherein the electrical heating element (5) extends through the chamber (1) along a main resistance axis (H), where the main resistance axis (H) and the main flow direction (V) form an angle (φ) of at least 0° and at most 90°, in particular in that the angle (φ) is 90°.

12. (canceled)

13. Apparatus (0) according to claim 11, characterized in that the main flow direction (V) runs vertically or
the main flow direction (V) runs vertically and counter to the acceleration due to gravity (g).

14. (canceled)

15. Apparatus (0) according to any of the preceding claims, characterized by a multitude of electrical heating elements (5) that are electrically interconnected in series and/or parallel connection.

16. Apparatus (0) according to any of the preceding claims, characterized in that the catalyst has been applied to the surface of at least one electrical heating element (5) in the form of a catalytically active coating.

17. Apparatus (0) according to claim 16, characterized by at least one heating element (5) which is free of any catalytically active coating.

18. Apparatus (0) according to any of the preceding claims, characterized in that the thermally insulating wall (2) of the chamber (1) has a multilayer design or wherein the thermally insulating wall (2) of the chamber (1) has a multilayer design and comprises at least two layers that differ with regard to their specific thermal conductivity.

19. (canceled)

20. Apparatus (0) according to claim 18, characterized by an additional inner layer on the wall of the chamber with a continuous surface.

21. Apparatus (0) according to any of claims 16 20, characterized in that the inner layer on the wall (2) of the chamber (1) has been provided with a catalytically active or activatable coating containing the catalyst.

22. Apparatus (0) according to any of the preceding claims, characterized in that the heating elements (5), viewed in main flow direction (V), are arranged in succession or arranged offset from another.

23. (canceled)

24. Apparatus (0) according to claim 22, characterized by at least one heating element (5) that runs parallel to the wall (2) directly adjacent to the wall (2) and is not connected to at least one of the two electrical leads (71, 72).

25. Apparatus (0) according to any of the preceding claims, characterized in that the catalyst contains platinum (Pt).

26. Apparatus (0) according to any of the preceding claims, characterized in that the heating element (5) comprises a core of silicon carbide or molybdenum silicide, with a protective coating applied to the core and a catalytically active coating applied to the protective coating.

27. Process for producing nitriles, especially hydrogen cyanide (HCN), comprising the following steps:
a) providing an apparatus (0) according to any of claims 1 to 26;
b) supplying the inlet (3) with a reactant gas mixture comprising at least ammonia (NH₃) and gaseous hydrocarbon, preferably methane (CH₄);
c) supplying the heating element (5) with electrical current drawn from the electrical voltage source (8);
d) drawing a product gas mixture comprising at least one nitrile formed, preferably hydrogen cyanide (HCN), from the outlet (4) and
e) charging the interspace (12) with a filling gas such that a gas pressure (p_{c}) in the interspace is equal to or greater than the reaction pressure (p_{R}) in the chamber (1).

28. Process according to claim 27, characterized in that the reactant gas mixture comprises methane (CH₄), such that hydrogen cyanide (HCN) is produced.

29. Process according to claim 27 or 28, wherein the reactant gas mixture additionally comprises oxygen (O₂), such that the reactant gas mixture can be assigned a limiting oxygen concentration (SGK) above which the reactant gas mixture is ignitable, characterized in that the oxygen concentration (KO₂) within the reactant gas mixture is below the limiting oxygen concentration (SGK).

30. Process according to any of claims 27 to 29, performed at a reaction pressure (p_{R}) within the chamber (1) of at least 1*10⁵ Pa absolute and at most 5*10⁵ Pa absolute.

31. Process according to any of claims 27 to 30, performed continuously in such a way as to result in a flow through the chamber (1) in a main flow direction (V) that extends from the inlet (3) to the outlet (4), where the heating element (5) extends through the chamber (1) along a main resistance axis (H), characterized in that the main flow direction (V) extends at right angles to the main resistance axis (H) of the heating element (5).

32. Process according to any of claims 27 to 31, performed at at least a reaction temperature (T_{R}) within the chamber (1) of greater than 800° C. and less than 1500° C., where the intermediate temperature (T_{c}) in the interspace (12) is less than 400° C.

33. Process according to any of claims 30 to 33, characterized in that the filling gas is selected from the group consisting of the following filling gases: gaseous nitrogen, gaseous hydrogen, gaseous hydrocarbon, gaseous ammonia or mixtures thereof.

34. Process according to any of claims 27 to 33, wherein an apparatus (0) according to any of claims 3 to 26 is provided, characterized in that the cooling fluid is drawn continuously from the cooling fluid source (13), the heat exchanger (10) is supplied continuously with the cooling fluid, and cooling fluid is drawn off continuously from the heat exchanger (10), where the temperature of the cooling fluid in the feed is lower than in the return, and where the cooling fluid is reactant gas mixture, and in that the cooling fluid sink is the chamber (1), such that the reactant gas mixture is preheated in the heat exchanger.

35. (canceled)

36. Use of an apparatus (0) according to any of claims 1 to 26 for provision of negative control power for the purpose of stabilizing power grids.
